(19) United States
(12) Patent Application Publication
(10) Pub. No.: US 2007/0076882 A1
(43) Pub. Date: Apr. 5, 2007

(54) Network component for a communication network, communication network, and method of providing a data connection

(75) Inventors: Christian Engel, Stahnsdorf (DE); Thomas Berndes, Stahnsdorf (DE); Andreas Gehring, Berlin (DE)

Correspondence Address: DAVIDSON BERQUIST JACKSON & GOWDEY LLP, 4300 WILSON BLVD., 7TH FLOOR, ARLINGTON, VA, 22203, US

(73) Assignee: ENGEL Technologieberatung, Entwicklung/Verkauf von Soft-und hardware KG, Stahnsdorf (DE)

(21) Appl. No.: 11/522,930

(22) Filed: Sep. 19, 2006

(30) Foreign Application Priority Data
Sep. 21, 2005 (DE) 10 2005 046 462.9

(51) Int. Cl. H04K 1/00

(52) U.S. Cl. 380/255

(57) ABSTRACT

This invention relates to a network component (11-16) for a communication network (1) in which multiple communication interfaces (31-37) are connected for mutual data exchange via a transmission network (20) and in which said network component (11-16) can be placed between at least one assigned communication interface (31-37) and the transmission network (20). The network component (11-16) according to the invention comprises a first memory facility (41) for storing at least one preset coding key (K1, K2, K3), a decrypter (51) for decrypting the encrypted data received via the transmission network (20) using the stored at least one coding key (K1, K2, K3) as well as a data selector (52) for the selective transfer of data between the transmission network (20) and the at least one assigned communication interface (31-37). Said data selector (52) is designed to automatically prevent transfer of encrypted data received via the transmission network (20) to the at least one assigned communication interface (31-37) if the decrypter (51) cannot decrypt the encrypted data using the at least one coding key (K1, K2, K3). The invention further relates to a respective communication network and a respective method of providing a data connection among at least two communication interfaces that can be connected via a transmission network.

### CROSS-REFERENCE TO RELATED APPLICATIONS

The present application claims priority to German Application Serial No. 10 2005 046 462.9 filed Sep. 21, 2005, the entire contents of which are herein incorporated by reference.

### DESCRIPTION

This invention relates to a network component for a communication network in which multiple communication interfaces for mutual data exchange are connected via a transmission network and the network component can be placed between at least one assigned communication interface and the transmission network.

This invention further relates to a respective communication network comprising a transmission network that facilitates data exchange and multiple communication interfaces linked to the transmission network which are suitable for data exchange via the transmission network.

This invention finally relates to a method of providing a data connection of at least two communication interfaces that can be interconnected using a transmission network, respective network components being provided between at least two of the communication interfaces each and the transmission network.

Such communication networks can be based on various transmission networks. In the simplest case, the transmission network is a data connection via a digital communication network such as an ISDN network. The communication interfaces in this case are a modern of a participant in the communication or a server of a network provider.

Alternatively, the transmission network may also be a local data network based on Ethernet or a global data network based on the Internet protocol. In this case, the communication interfaces may just be a network adapter connected to a personal computer.

However the present invention is not limited by these examples. Instead, any data network or other communication network that allows exchange of digital data between at least two communication interfaces and therefore at least two participants in the communication may be used as transmission network for the purposes of the invention.

In such transmission networks, individual connections among communication interfaces are typically set up by participants in the communication in that each communication interface is assigned a unique communication address. This communication address is either prescripted by hardware based in the communication interface or is dynamically assigned by the transmission network.

There is always a risk in a transmission network with several communication participants that unauthorized parties tap or intercept data transferred among these participants via the transmission network. Furthermore, there is a risk that an unauthorized party tries to access the communication interfaces used by the participants in the communication or any personal computers, servers, etc. that may be connected to them.

A known solution to these problems is to transmit encrypted data between two communication participants. This requires that the two communication participants between whom the data is to be transmitted exchange a coding key to be used. Then the data from the transmitting participant in the communication has to be encrypted using the coding key and sent via the transmission network. The data received by the receiving participant in the communication then has to be decrypted using the coding key.

A coding key in this meaning is a set of data in the form of bytes that is used by an encryption or decryption algorithm to encrypt or decrypt data. The coding keys used may either be symmetrical or asymmetrical coding keys.

This approach has the disadvantage that a manual intervention by the user is required for encryption and decryption. In addition, exchanging the coding key used is problematic in practice as it is frequently exchanged via the transmission network and there is a risk that the coding key is tapped into or intercepted by an unauthorized party. Furthermore, a separate software is required for encrypting and decrypting the data which often is not very convenient to use.

As a result, particularly less experienced users find it considerably difficult to exchange encrypted data via a transmission network. Data encryption also does not provide any protection against an attack over the transmission network as the communication interface also receives unencrypted data.

Another known solution to the problems described is to provide a firewall between the communication interfaces of each participant in the communication and the transmission network. A firewall is a facility that shields communication interfaces from the transmission network and prevents external access to the communication interface. The firewall analyzes and checks data received from the transmission network before forwarding it to the communication interface. In addition, firewalls are often designed to restrict a participant's access to the transmission network. Thus the firewall identifies a transmitting communication address of a transmitting communication interface in data received and decides if data exchange with this communication interface should be allowed. In this way the firewall automatically prevents access to communication interfaces that are rated insecure.

Such a firewall is described in German patent application DE 10340181.

The disadvantage of such a firewall is that its installation is fairly complicated. This is because the firewall has to be set up to allow reliable data transfer between communication interfaces of the communication network and ensure a sufficient degree of security. Use of a firewall cannot prevent tapping into or intercepting data transmitted among communication interfaces in the transmission network.

Based on this situation, it is the object of this invention to provide a network component for a communication network, a communication network, and a method of providing a data connection that facilitates a particularly simple and reliable way to exchange data securely between at least two communication interfaces interconnected by a transmission network without requiring user intervention.

It is further the object of this invention to make access of an unauthorized party via the transmission network to a communication interface connected to the transmission network more difficult.

The above objects are achieved by a network component for a communication network with the characteristics of the introductory clause of independent claim 1 by the properties described in the characterizing part of independent claim 1.

The above objects are further achieved by a communication network with the characteristics of independent claim 39 and a method of providing a data connection with the characteristics of independent claim 46.

Advantageous improvements can be found in the respective dependent claims.

A first aspect of this invention relates to a network component for a communication network in which multiple communication interfaces for mutual data exchange are connected via a transmission network and the network component can be placed between at least one assigned communication interface and the transmission network. According to the invention, the network component comprises a first memory facility for storing at least one preset coding key, a decrypter for decrypting encrypted data received via the transmission network using the at least one coding key stored, as well as a data selector for optional data transmission between the transmission network and the at least one assigned communication interface. The data selector is designed to automatically prevent transmission of encrypted data received via the transmission network to the at least one assigned communication interface if the decrypter cannot decrypt the encrypted data using the at least one coding key.

It is automatically ensured by providing the network component of the invention between a respective assigned communication interface and the transmission network that only such data is passed on that can be decrypted using a preset coding key stored in the network component. The network component of the invention can in the most simple case be designed so that when it receives encrypted data it attempts to decrypt it with all preset coding keys stored in the first memory facility of the network component to determine if the data is decryptable. Obviously, data transmission according to the invention will only be successful if a transmitting communication interface encrypts the data prior to sending it via the transmission network using a coding key that is also stored in the first memory facility of the network component assigned to the receiving addressed communication interface.

The decision which communication interfaces connected to the transmission network may exchange data solely depends on which preset coding keys are stored in the first memory facility of the network component and which coding keys the other communication interfaces connected to the transmission network use to encrypt the data to be transmitted. As the network component works automatically, it is sufficient to place the network component between the respective assigned communication interface and the transmission network. The user does not need to configure the component nor intervene in any other way.

According to a preferred embodiment, the data selector is designed to automatically forward encrypted data received from the transmission network after decryption by the decrypter using at least one coding key to at least one assigned communication interface.

The network component may comprise a first interface for connecting the network component with the at least one assigned communication interface and a second interface to connect the network component to the transmission network, the first interface being connected to the data selector and the second interface being connected to the decrypter.

Thus the network component is preferably a facility that can be detachably connected to an assigned communication interface and the transmission network using interfaces.

This makes the flexible setup of a network that overlays the transmission network by providing the network component of the invention considerably easier.

Furthermore, the decrypter can be designed to automatically identify key information that identifies the coding key used for encryption in encrypted data received from the transmission network.

It is then no longer required for decrypting the encrypted data received to test all coding keys contained in the first memory facility. Instead, the component can apply a coding key suitable for decrypting the encrypted data. Such key information may be explicitly or implicitly contained in the encrypted data received. For example, it is often possible to draw conclusions about the encryption method and coding key used by analyzing encrypted data. The key information may also have been added intentionally to the data to make it easier to identify a coding key used for their encryption.

In this case it may be useful, if the key information is a key identifier added unencrypted to the encrypted data received from the transmission network.

After this, identifying the key information is particularly fast, simple, and reliable.

One communication address each may be assigned to the communication interfaces of the transmission network for address assignment for mutual data exchange. Then the key information of the communication addresses used for addressing the communication interfaces preferably differs.

Thus the key information is independent of the transmission network used and does not have to be adjusted when the transmission network or the addresses used in it change. This makes the use of the network component without user intervention according to the invention particularly flexible.

According to a preferred embodiment, the network component further comprises an encrypter for encrypting the data received from the assigned communication interface using at least one stored coding key. The data selector is designed to automatically output data that is received from the assigned communication interface, to the transmission network only after encryption by the encrypter using at least one stored coding key.

Thus the network component of the invention allows bidirectional data exchange of a communication interface assigned to the network component with another communication interface that is connected via the transmission network and to which a network component according to the invention is assigned as well. The respective network component of the invention ensures by encryption that the data transmitted in the transmission network cannot be intercepted by an unauthorized party. As the data are automatically encrypted by the encrypter, the network component according to the invention does not require any user intervention. The encrypter may further be designed to add random data to the data to be encrypted prior to encryption in order to conceal the coding key used in the encrypted data.

It may further be advantageous if a key identifier is stored in the first memory facility that identifies the at least one preset coding key, and if the encrypter is designed to automatically add the key identifier of the coding key used in unencrypted form to the data encrypted using said coding key after the encryption process.

This enables another network component that receives the encrypted data via the transmission network to identify the coding key required for decrypting the encrypted data in a particularly simple way. As a result, the data can be decrypted particularly fast and easy.

The encrypter may further be designed to automatically calculate a check value for the data to be encrypted or the encrypted data to be received by the assigned communication interface and to add the calculated check value prior to encryption to the data to be encrypted or after the encryption to the encrypted data. Alternatively, such a check value may already be contained in the data to be encrypted originally.

A second network component that is assigned to a communication interface receiving the encrypted data via the transmission network can use this check value to determine automatically and in a simple way if the data is complete and/or was decrypted correctly.

According to one embodiment, the decrypter is also designed to automatically identify a check value in the encrypted or decrypted data, to calculate a check sum for the data decrypted using the at least one coding key, or to calculate the encrypted data and compare the check sum with the check value. The data selector is designed to automatically prevent transmission of decrypted data to the at least one assigned communication interface if the check sum does not match the check value.

By comparing the check sum with the check value, the encrypter can determine in a particularly simple and reliable way if the encrypted data is complete and was decrypted correctly. It is ensured that the assigned communication interface does not receive incorrectly decrypted or incompletely received data as the data selector will only forward the decrypted data to the assigned communication interface if the check sum matches the check value. Thus, the data transferred to the assigned communication interface will always have a preset minimum quality.

According to one embodiment, the data selector may further be designed to automatically prevent the transfer of unencrypted data received from the transmission network to the at least one assigned communication interface.

Thus, the network component of the invention only permits encrypted data exchange between communication interfaces connected via the transmission network, and a preset common key must be used. As the coding key is not known to an unauthorized party, there can be no attack on the assigned communication interface from the transmission network.

The network component may preferably comprise a second memory facility that is permanently integrated into the network component and in which at least one specification of a transmission protocol used in the communication network is stored. Then the decrypter is preferably designed to use this stored specification to detect an unencrypted protocol data part that can only be put down to the respective transmission protocol used and an encrypted user data part containing the remaining data in the encrypted data received from the transmission network and to use the at least one coding key to decrypt only the encrypted user data part.

Provision of a second memory facility in which at least one specification of the transmission protocol used in the communication network is stored enables the decrypter to automatically identify a transmission protocol used for the data exchange in the encrypted data received from the transmission network. As a result, the protocol data part and the user data part can easily be detected in the data received. The transmission protocol is a specification that contains the partitioning of a data stream or data packet into individual components such as a protocol data part and a use data part for a data exchange via a specifications of transmission network. The transmission protocol can further contain potential values and meanings of components contained in the protocol data part. These components may be communication addresses, the size and partitioning of data, or other control data. The transmission protocol may also specify interaction between the contents of the protocol data part and the user data part.

In this case the decrypter may further be designed to automatically create a new protocol data part for the decrypted user data part using the stored specifications and the detected protocol data part.

In this way, the decrypter can particularly easily form decrypted data that matches the identified transmission protocol based on the new protocol data part and the decrypted use data part. The formation of a new protocol data part may be required, for example, if the size of the user data part and/or the partitioning of the decrypted data into data packets changes.

The decrypter may further be designed to automatically identify a communication address used in the transmission network for addressing a respective addressed communication interface in the detected protocol data part and to create the new protocol data part for the decrypted use data part while retaining the detected communication address.

Retaining the originally used communication address when creating the new protocol data part makes the network component according to the invention transparent to the transmission network. Transparency means in this context that a communication address of an addressed communication interface contained in the protocol data part of data received by the network component of the invention is identical with the communication address of an addressed communication interface contained in the protocol data part of data output by the network component. This does not rule out, however, that the communication address of the transmitting communication interface contained in the protocol data part of data may be changed by the network component of the invention. As a result, the transmission network does not need to be adjusted to integrate the network component between the transmission network and the at least one assigned communication interface. Furthermore, the network component does not need to be assigned its own communication address addressable through the transmission network for data exchange with the communication interfaces.

According to another embodiment, the decrypter is designed to receive an unencrypted protocol data part that indicates a communication address used for addressing the respective communication interface in the respective transmission network via a first channel of the transmission network, an encrypted user data part that contains data to be transferred among communication interfaces via a second channel different from the first channel of the transmission network, and to decrypt only the encrypted user data part using at least one coding key.

Thus the network component of the invention can also be used in transmission networks in which the data of a protocol data part and of a user data part is transmitted on different channels. This applies, for example, to ISDN communication networks. It is obvious in this context that these channels do not need to be separated physically; a software-implemented separation is sufficient.

Preferably, the decrypter can further be designed to automatically identify a communication address used in the transmission network for addressing a respective transmitting communication interface in the protocol data part it either detected or received via the first channel, and store this protocol data part together with a key identifier that denotes the coding key used for decryption in the first and/or second memory facility. This information can be stored in a database, for example.

As a result, the network component of the invention can automatically record which data transfers were successful with which communication interfaces and which coding keys.

In addition, the decrypter can be designed to automatically identify the communication address used for addressing a respective transmitting communication interface in the protocol data part it either detected or received via the first channel, search in the first and/or second memory facility for a key identifier associated with this communication address, and use the coding key assigned to the key identifier to decrypt the encrypted user data part.

This considerably accelerates the selection of a coding key suitable for decryption. The reason is that the decrypter resorts to coding keys that resulted in successful decryption of the encrypted data for data connections with a respective transmitting communication interface in the past.

The encrypter can further be designed to automatically identify a communication address used for addressing the respective addressed communication interface in the protocol data part it either detected or received via the first channel, search in the first and/or second memory facility for a key identifier associated with this communication address, and use the coding key assigned to the key identifier to encrypt the data.

As a result, the encrypter automatically uses coding keys that enabled data exchange with a communication address associated with a respective addressed communication interface in the past. It is thus automatically determined which preset coding keys enable data exchange with this communication interface.

Alternatively or in addition, the encrypter can be designed to automatically encrypt preset test data using any of the preset coding keys stored in the first memory facility and transmit it via the transmission network to a respective addressed communication interface if no key identifier assigned to the communication address used for addressing the respective addressed communication interface is stored in the first and/or second memory facility.

The test data preferably cause automatic transmission of a receipt acknowledgement after successful decryption using the preset coding key by the addressed communication interface. Thus the encrypter can determine automatically which coding key is known to a network component assigned to an addressed communication interface.

If no key identifier assigned to the communication address used for addressing the respective addressed communication interface is stored in the first and/or second memory facility, the encrypter, according to one embodiment of the invention, can further be designed to automatically send unencrypted user data specifying all or a subset of the key identifiers stored in the first and/or second memory facility of the network component via the transmission network to a respective addressed communication interface.

Sending unencrypted user data specifying all or a subset of the key identifiers stored in the first and/or second memory facility of the network component is not critical because the key identifiers merely identify but do not contain the coding keys. Consequently, if these key identifiers sent without encryption are tapped into or intercepted, this does not enable an unauthorized party to encrypt or decrypt data using the coding keys.

The decrypter can further be designed, when receiving unencrypted use data specifying various key identifiers via the transmission network, to automatically compare the key identifiers specified with all key identifiers stored in the first and/or second memory device of the network component, identify the communication address used to address the respective transmitting communication interface in the protocol data part detected or received via the first channel associated with the use data received, and send unencrypted use data containing all common key identifiers to the respective transmitting communication interface via the transmission network.

The decrypter may further be designed, when receiving unencrypted use data via the transmission network that specify common key identifiers, to automatically identify the communication address used to address the respective transmitting communication interface in the protocol data part detected or received via the first channel associated with the use data received, and to store it together with the common key identifiers in the first and/or second memory facility.

Subsequently, network components of the invention assigned to different communication interfaces can automatically and without user intervention agree on the use of mutually known coding keys without having to transmit the coding keys via the transmission network. Storing the communication address assigned to the respective transmitting communication interface together with the respective common key identifier automatically ensures that the network component of the invention will use a coding key that is associated with the common key identifier for future mutual data exchanges with this communication address.

According to one embodiment, the encrypter is further designed to automatically detect a protocol data part to be merely put down to the transmission protocol used and a use data part containing the remaining data in the data received from the assigned communication interface using the stored specifications and to encrypt only the use data part using the at least one coding key.

Encryption of only the use data part ensures that the protocol data part remains readable for the transmission network and communication interfaces connected to the transmission network.

The encrypter may then further be designed to automatically create a new protocol data part for the decrypted use data part using the stored specifications and the detected protocol data part.

The new protocol data part can be created in a particularly simple manner as the detected protocol data part typically contains the essential information for the respective transmission protocol such as the communication addresses of the transmitting and receiving communication interfaces. As a rule, all that is required is adjustment to the new size of the encrypted data and partitioning the encrypted data into data packets. Consequently, the encrypted data formed of the new protocol data part and the encrypted user data part comply with the respective transmission protocol of the respective transmission network.

The encrypter may further be designed to automatically identify a communication address used in the transmission network for addressing a respective addressed communication interface in the detected protocol data part and to create the new protocol data part for the decrypted use data part while retaining the detected communication address.

As a result, the network component of the invention is also transparent to data sent from the assigned communication interface to the transmission network.

The first memory facility and/or the second memory facility may be a permanently incorporated non-volatile memory.

When the first and second memory facilities are permanently incorporated, they cannot be inconspicuously detached from the network component to read out stored data. The network component according to the invention also is an autonomous system.

The network component may further comprise a management facility designed to change settings of the network component.

The settings set by the management facility may relate to decrypter, encrypter, and data selector states. Furthermore, the management facility may be used to manipulate data stored in the first and/or second memory facility and in particular to manage the preset coding keys. The management facility may specifically be used to monitor and maintain the network component.

A communication address that can be addressed via the transmission network may be assigned to the management facility. Furthermore, the management facility may be connected to the transmission network to exchange management data.

Thus the network component of the invention can be configured and maintained using the management facility that is connected to the transmission network. Data from and to the management facility preferably is exchanged using encrypted data that is encrypted or decrypted by the management facility using a special preset coding key.

The network component may comprise a first identification system for determining the identity of a user, said identification system only allowing memory readout and / or a management system activity after the user has been successfully identified.

Subsequently, all major functions of the network component of the invention will be determined by the successful identification of a user. In particular, the network component of the invention will only allow a successfully identified user to perform data exchange between the assigned communication interface and the transmission network.

According to one embodiment, the first memory facility is a removable non-volatile storage medium, and the network component comprises a memory interface for the removable storage medium. Furthermore, the second memory facility in this embodiment is a non-volatile memory permanently incorporated into the network component.

This makes the distribution of the preset coding keys particularly simple and flexible. For example, various storage media can be provided with various preset coding keys. Depending on which storage medium with which coding keys is connected to the network component via the memory interface, the network component can perform a data exchange with a different set of communication interfaces connected via the transmission network and their associated network components. For example, one work group in one company may always be provided with the data connections assigned to this work group, regardless of which communication interfaces the members of this work group are using for data exchange. This is possible because the members of the work group simply load their assigned preset coding keys using the removable storage medium and the memory interface into a respective network component.

The removable storage medium may be a diskette, a compact disk CD, a digital versatile disk DVD, a smart card, or a USB token.

Such removable storage media are cost-efficient, widespread, and sufficiently reliable and robust.

The removable storage medium may preferably comprise a second identification system for determining a user's identity, and the identification system will only allow reading out the removable storage medium after successful identification of the user.

There is a general risk with removable non-volatile storage media that unauthorized parties may read out the stored data if the storage media are stolen or lost. This is critical if the storage media contain sensitive data such as the coding keys in our example. The second identification system prevents unauthorized reading of the storage media or makes it considerably more difficult.

In addition, an unique storage medium ID may be assigned to the removable storage medium, and the encrypter can be designed to automatically read the storage medium ID of a removable storage medium connected to the network component via the memory interface for removable storage media and add the storage medium ID to the data to be encrypted or to the encrypted data. Encrypter and decrypter may preferably be designed to read a storage medium ID added to data received and use it instead of a communication address identified in the data received.

As mentioned before, the use of removable storage media enables a user to exchange data using any communication interface assigned to a network component by reading the preset coding keys stored on the removable storage medium into that network component. As the communication address of the communication interface changes depending on the network component used, the addition of the storage medium ID to the data transmitted allows simple user identification.

The identification system may comprise a keyboard for entering a personal identity code and/or a sensor for capturing biometric data.

Furthermore, the network component may contain a unique network component ID. Then the encrypter may be designed to read the network component ID automatically and add the network component ID of the network component to the data to be encrypted.

This allows easy analysis of which network component was used for a data exchange.

According to one embodiment, metadata may be assigned to the coding keys stored in the first memory facility, and the metadata may contain information on the way in which the respective coding key is used. In addition or alternatively, metadata may be stored in the second memory facility that are each assigned to a key identifier of a coding key.

Encrypter, decrypter, data selector, and preferably the management facility may be integrated into a microprocessor.

This makes the implementation of the network component particularly cost-effective.

The microprocessor may preferably comprise an operating system that is different from an operating system of the at least one communication interface assigned.

This protects the network component according to the invention particularly well against manipulation by unauthorized parties via the transmission network as an unauthorized party does not know the structure of the operating system. In this way, functioning of the network component according to the invention is even ensured if an operating system used by the assigned communication interface has a defect or weak point.

According to another aspect, this invention relates to a communication network comprising a transmission network that enables data exchange and multiple communication interfaces connected to the transmission network. The communication interfaces are designed for data exchange via the transmission network. The communication network further comprises at least two network components with the characteristics of claims 1 through 38. The network components are each assigned to at least one communication interface and placed between the respective assigned communication interface and the transmission network.

If at least one common coding key is stored in the respective first and/or second memory facility of the two or more network components connected via the transmission network, the communication interfaces assigned to the two network components may exchange data via the transmission network. As this data exchange is encrypted, unauthorized parties cannot tap or intercept it or will at least have great difficulty doing this. The network components of the communication network according to the invention implicitly release or block data transmission paths among assigned communication interfaces by means of the encryption or decryption of the data to be transferred without requiring any user intervention. These implicit data transmission paths overlay the transmission network. As the network components prevent forwarding of data received unencrypted to the respective assigned communication interface, they also effectively prevent an unauthorized party from accessing these communication interfaces.

At least one of the two or more network components may be placed between multiple assigned communication interfaces and the transmission network.

Thus the network component of the invention can connect more than just one communication interface with the transmission network. For example, a subnetwork can be incorporated in this way into the transmission network.

A unique communication address may further be assigned to the communication interfaces for addressing them in the process of mutual data exchange, and the network components are designed in such a way that the respective communication address of the assigned communication interface is visible to the transmission network.

The network components of the communication network according to the invention are therefore preferably transparent to the transmission network.

According to one embodiment, the communication interfaces are designed to encode data to be transferred in accordance with a transmission protocol used by the transmission network before outputting it to the respective associated network component. The network components are designed to process the data received from the associated communication interface in such a way (to encrypt or decrypt it) that the processed data is encoded according to the protocol used by the transmission network as well.

A communication address can be assigned to each communication interface while the transmission network may comprise switches and/or routers that provide controlled data channels between the communication interfaces based on the communication address.

The transmission network preferably provides an IEEE802.3 Ethernet connection or an IEEE802.11 wireless LAN connection or an ISDN connection or a GSM connection or an UMTS connection or a TCP/IP connection among the communication interfaces.

Thus the communication network of the invention may be based on the common known transmission networks.

According to one embodiment, the network component may be a separate unit from the respective assigned communication interface.

This ensures simple construction of the communication network according to the invention by placing the network component of the invention between one of at least one assigned communication interface and the transmission network.

According to yet another aspect of this invention, a method of providing a data connection among at least two communication interfaces that can be linked using a transmission network, wherein a network component is provided among at least two of the communication interfaces and the transmission network, comprises the following steps: Receipt by the respective network component of encrypted data sent from a communication interface via the transmission network before the data is output to the respective communication interface. Decrypting the encrypted data received using at least one preset coding key. Forwarding the data decrypted by the network component to the respective communication interface for providing a data connection if the encrypted data can be decrypted using the at least one coding key.

As the network component, according to the invention, only forwards data to the respective communication interface that can be decrypted using at least one preset coding key, the method according to the invention implicitly establishes data connections via the transmission network depending on preset coding keys to communication interfaces only that encrypt the data to be transmitted using at least one preset coding key.

The method may further comprise the following steps: Identifying key information contained in encrypted data received from the transmission network that denotes a coding key used for the encryption. Using that preset coding key for decrypting the data that matches the key information detected.

The method may further comprise the following steps: Encrypting the data to be transferred by a communication interface via the transmission network before forwarding the data to the transmission network by the network component using at least one preset coding key. Outputting the encrypted data to the transmission network.

The method may further include the step of adding a key identifier denoting one of the coding keys used during encryption to the encrypted data before outputting the encrypted data to the transmission network.

According to one embodiment, the method further comprises the steps of calculating a check value for the data to be encrypted and adding the check value to the data to be encrypted prior to encryption or to the encrypted data after encryption.

The method may further comprise the following steps: Identifying a check value in the encrypted data or in the decrypted data. Calculating a check sum for the data decrypted using the at least one coding key. Comparing check sum and check value. Preventing the transfer of the decrypted data to the at least one assigned communication interface if the check sum does not match the check value.

The method according to the invention may further include the following steps: Receiving by the respective network component of unencrypted data sent from a communication interface via the transmission network. Detecting that the data received is not encrypted using a preset coding key. Preventing the transfer of the unencrypted data received to the at least one assigned communication interface by the network component.

The method may further comprise the following steps: Identifying a transmission protocol used in the transmission network based on the encrypted data received from the transmission network using specifications of known transmission protocols. Detecting an unencrypted protocol data part that can only be put down to the transmission protocol, and an encrypted user data part containing the remaining data, in the encrypted data received. And decrypting just the encrypted use data part using the at least one coding key.

Other steps may include the creation of a new protocol data part using the specification of the identified transmission protocol and the detected protocol data part, and formation of decrypted data according to the identified transmission protocol from the new protocol data part and the decrypted use data part.

Furthermore, the method may include the steps of identifying a communication address used in the transmission network for addressing a respective addressed communication interface in the detected protocol data part and creating a new protocol data part for the decrypted communication address.

According to one embodiment, the method further comprises the following steps: Receiving an unencrypted protocol data part via a first channel of the transmission networks, said protocol data part specifying a communication address used in the respective transmission network for addressing a respective communication interface. And receiving an encrypted user data part via a second channel of the transmission network that is different from the first channel of the transmission network, said use data part containing data to be transferred among communication interfaces. It is preferred here that only the use data part received from the second channel is decrypted using the at least one preset coding key.

The method may also include the steps of identifying a communication address used in the transmission network for addressing a respective transmitting communication interface in the protocol data part detected or received via the first channel, and mapping the identified communication address with a key identifier that denotes the coding key used for decryption after decrypting the use data part received.

Furthermore, the method may comprise the following steps: Identifying a communication address used for addressing a respective transmitting communication interface in the protocol data part of the data to be decrypted that was detected or received via the first channel. Searching for a key identifier assigned to this communication address. And using the coding key associated with this key identifier to decrypt the data.

According to one embodiment, the method may further include the following steps: Identifying a transmission protocol used in the transmission network based on the unencrypted data received from the respective at least one assigned communication interface using specifications of known transmission protocols. Detecting an unencrypted protocol data part that can only be put down to the respective transmission protocol used, and a user data part containing the remaining data, in the data received. And decrypting just the use data part using the at least one coding key.

Other steps may include the creation of a new protocol data part for the encrypted use data part using the specification of the identified transmission protocol and the detected protocol data part, and formation of decrypted data according to the identified transmission protocol from the new protocol data part and the decrypted use data part.

The method may further include identifying the communication address used in the transmission network for addressing a respective addressed communication interface in the detected protocol data part and forming the new protocol data part for the encrypted use data part while retaining the detected communication address.

Other steps the method may include are identifying of a communication address used for addressing a respective addressed communication interface in the protocol data part detected or received via the first channel, searching for a key identifier associated with this communication address, and using the coding key assigned to the respective key identifier for encryption.

If no key identifier is assigned to the communication address used for addressing the respective addressed communication interface, the method may further include the following steps: Encrypting preset test data using any one of the preset coding keys, and transmitting the encrypted test data to a respective addressed communication interface.

Alternatively, the method may include the creation of unencrypted use data that specifies key identifiers that denote all preset coding keys, and transmission of the unencrypted use data to a respective addressed communication interface, if no key identifier is assigned to the communication address used to address a respective communication interface.

According to one embodiment, the method further comprises the following steps: Detecting that unencrypted user data specifying several key identifiers was received from the transmission network. Comparing several key identifiers specified in the unencrypted use data received with the preset key identifiers that denote the preset coding keys. Identifying a communication address used for addressing a respective transmitting communication interface in the protocol data part detected or received via the first channel for the unencrypted user data received. Creating unencrypted user data specifying all common key identifiers. And sending the unencrypted use data to a respective transmitting communication interface.

The method may also include the following steps: Detecting that unencrypted user data was received from the transmission network that specifies common key identifiers. Identifying a communication address used for addressing a respective transmitting communication interface in the protocol data part detected or received via the first channel for the unencrypted use data received. And assigning the identified communication address to the common key identifiers.

The method further comprises the following steps: Verifying a user's identity. Comparing the detected identity with the identities of approved users. And encrypting or decrypting using a preset coding key, only if the detected identity is assigned to an approved user.

It is preferred that the steps described are performed according to any one of claims 1 through 38.

Preferred embodiments of the invention are described with reference to the attached figures below. If at all possible, the same or similar reference symbols were used in the figures to refer to the same or similar elements. Wherein

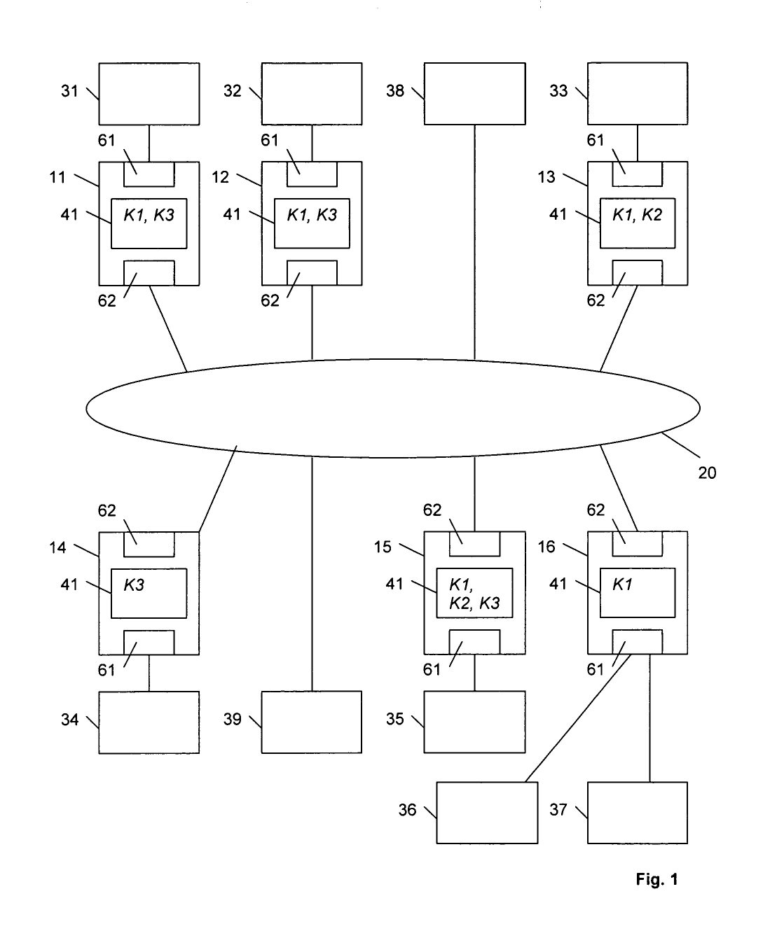

FIG. 1 shows a schematic diagram of the structure of a communication network according to a preferred embodiment of this invention;

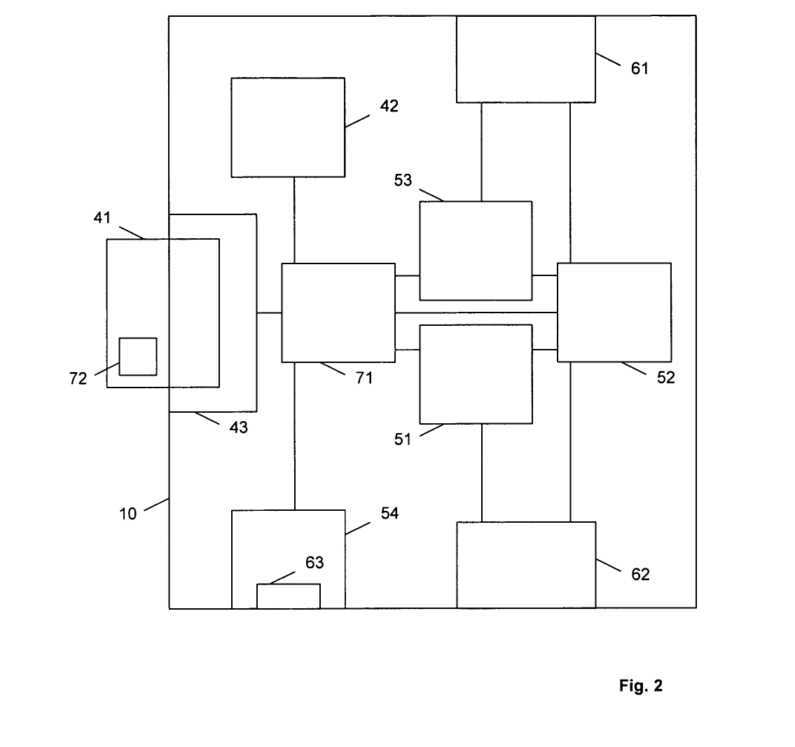

FIG. 2 shows a schematic diagram of the structure of a network component according to the preferred embodiment of this invention;

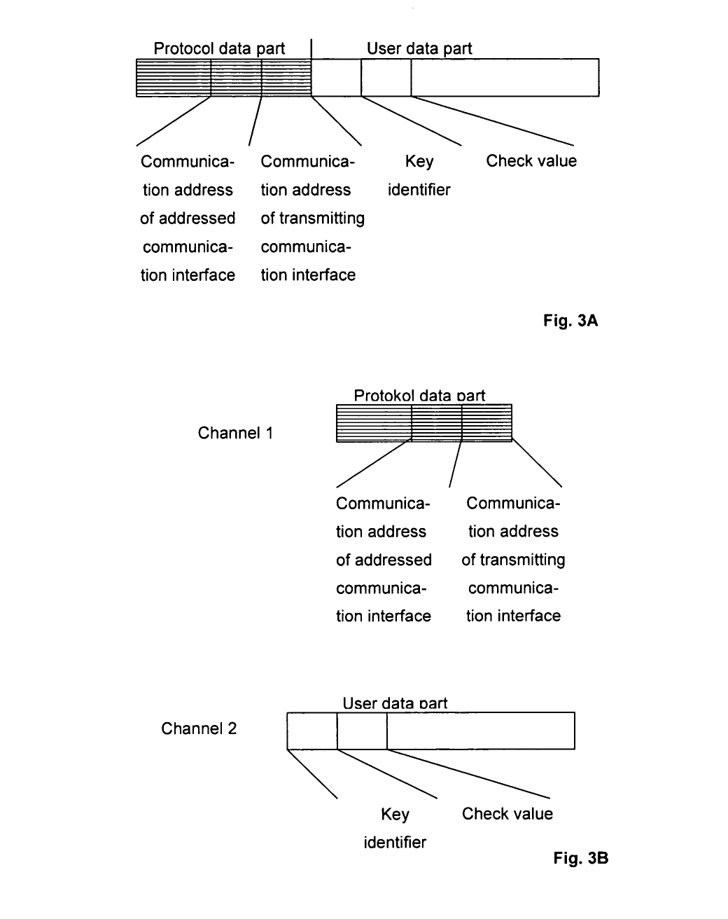

FIG. 3A shows a schematic diagram of the structure of data that can be transmitted via a first transmission network;

FIG. 3B shows a schematic diagram of the structure of data that can be transmitted via a second transmission network, and

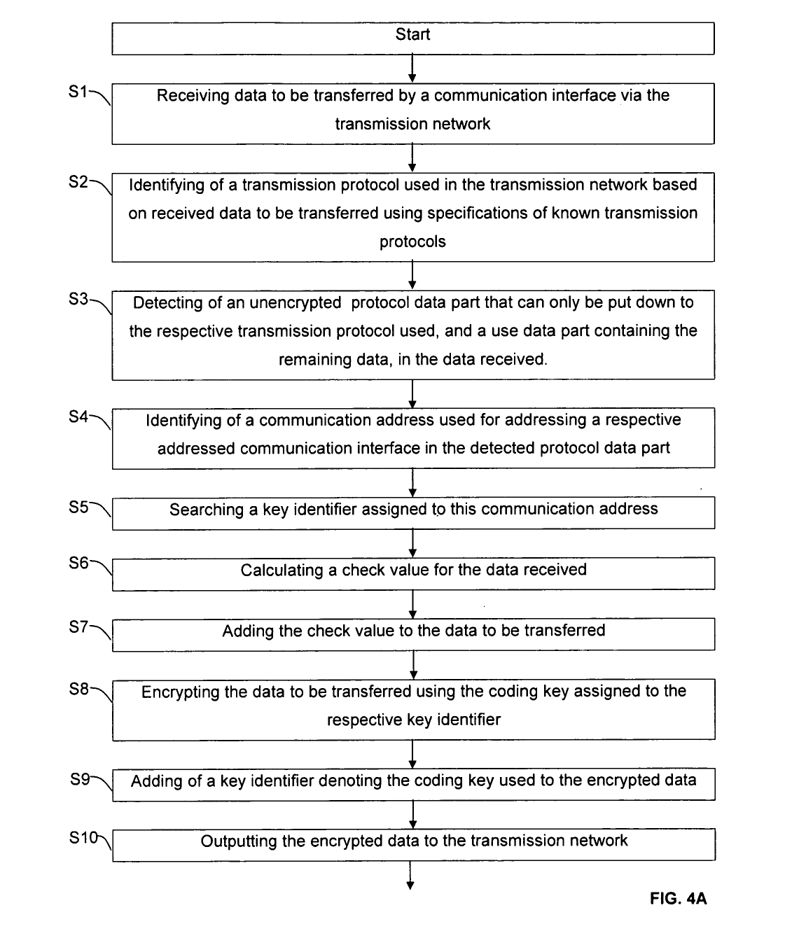

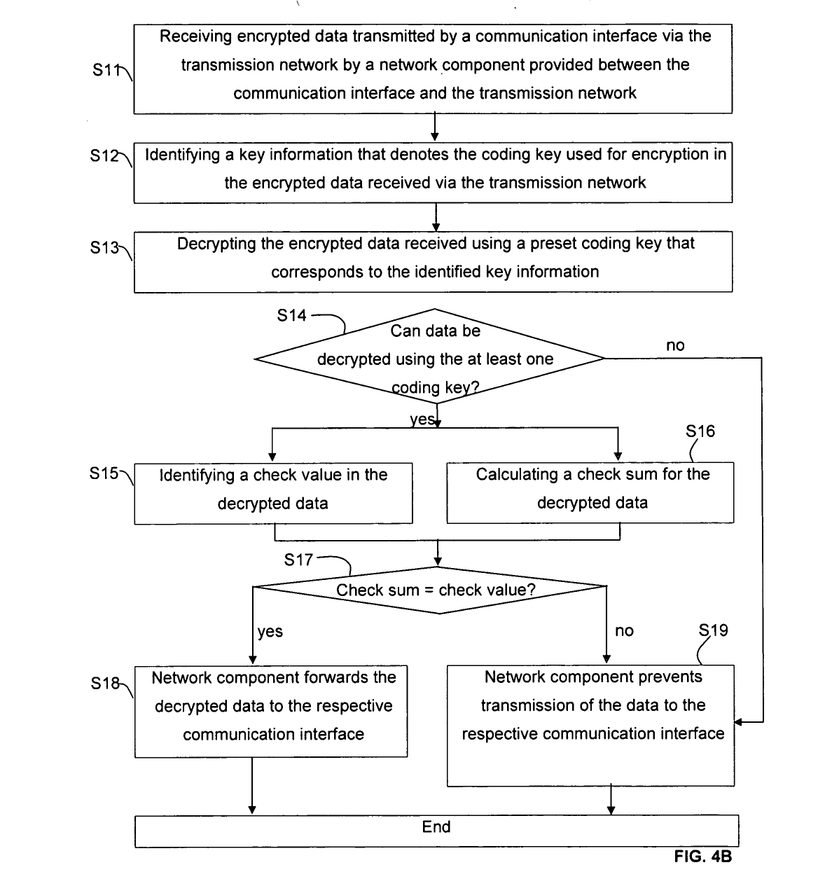

FIGS. 4A, 4B show a flowchart of a preferred embodiment of the method according to the invention for providing a data connection.

The description below refers to the attached figures and describes a preferred embodiment of the network component of the invention, the communication network of the invention, and the method of the invention for providing a data connection among at least two communication interfaces that can be interconnected via a transmission network.

The communication network 1 comprises a transmission network 20 to which first to ninth communication interfaces 31-39 are connected. First to fifth network components 11-15 are provided between the first to fifth communication interfaces 31 to 35 and the transmission network 20. A common sixth network component 16 is provided between the sixth and seventh communication interfaces 36 and 37 and the transmission network 20.

The first to sixth network components 11-16 each comprise a first interface 61 and a second interface 62. The first to seventh communication interfaces 31-37 are each connected to the first interface 61 of the associated first to sixth network components 11-16. The respective network components 11-16 are connected to the transmission network 20 via the second interface 62. A communication address is assigned to each communication interface 31-39 depending on the transmission protocol used in the transmission network 20.

In the embodiment shown in FIG. 1, the transmission network 20 provides a TCP/IP connection among the connected first to ninth communication interfaces 31-39 to enable data exchange among virtually all communication interfaces 31-39. The transmission network 20 comprises switches and/or routers not shown in FIG. 1 which provide data channels between the communication interfaces 31-39 in a controlled manner based on the communication addresses. The network components 11-16 are designed in a way that the respective communication address of the at least one assigned communication interface 31-37 is visible to the transmission network 20 and can thus further be used by the transmission network 20 for addressing the respective assigned communication interface 31-39.

Alternatively, the transmission network 20 may also be another data or communication network that enables digital data transfer such as an IEEE 802.3 network, or an IEEE 802.11 WLAN network, an ISDN network, a GSM network, or an UMTS network.

Accordingly, the first to ninth communication interfaces 31-39 are designed for data transfer via a TCP/IP network and encode data to be transmitted before sending them according to a transmission protocol used by the transmission network 20.

In FIG. 1, the first, second, fourth, and eighth communication interfaces 31, 32, 34, 38 are network cards of a personal computer. The third and fifth communication interfaces 33 and 35 just like the ninth communication interface 39 are network cards of servers. The sixth and seventh communication interfaces 36 and 37 each are WLAN cards connected to a corresponding first interface 61 of the associated sixth network component 16. The communication interfaces may also be an ISDN modem or the like depending on the transmission network used.

In FIG. 1, the first, second, third, and sixth network components 11, 12, 13, and 16 of the assigned communication interfaces are separate devices that are inserted into a line between the respective communication interfaces 31, 32, 33, 36, and 37 and the transmission network 20; However, the fourth and fifth network components 14 and 15 are permanently integrated into a fourth or fifth communication interface 34 and 35, respectively. They can be integrated in form of a PCI bus card or directly on the main board of the respective computer.

Each network component comprises a first memory facility 41 in which a preset coding key is stored. In FIG. 1, coding keys K1 and K3 are stored in the first memory facility 41 of the first and second network components 11 and 12, respectively. Coding keys K1 and K2 are stored in the first memory facility 41 of the third network component. Coding key K3 is stored in the first memory facility 41 of the fourth network component 14, coding keys K1, K2 and K3 in the first memory facility 41 of the fifth network component 15, and coding key K1 in the first memory facility 41 of the sixth network component.

FIG. 3A shows a schematic diagram of the structure of the data transferred by the transmission network 20.

As can be seen, the data comprise a protocol data part and a use data part. The protocol data part depends on a transmission protocol used in the transmission network 20 and contains the communication address of an addressed communication interface 31-39 and the communication address of a transmitting communication interface 31-39. The protocol data part is always unencrypted, i.e. encoded just in accordance with a transmission protocol used in the transmission network 20 to enable transfer via the transmission network 20.

The user data part may be encrypted or unencrypted and contains the user data and, in the example shown, a check value that is calculated from the use data and is used to determine if the use data part is complete and free of errors. It is preferred that the check value also enables adjustment of a faulty user data part. If the user data is encrypted, the user data part in the embodiment shown additionally contains an unencrypted key identifier that denotes one coding key K1, K2, K3 used for encryption.

The data shown in FIG. 3A can be transferred in the transmission network 20 shown in FIG. 1 which uses a common channel for the data to be transmitted.

FIG. 3B however shows the structure of data that can be used in a data network that uses different channels for transferring a protocol data part and a use data part of the data to be transmitted. This applies, for example, to ISDN networks in which the protocol data part is transferred via a first channel and the use data part via a second channel.

The structure of the protocol data part and the use data part is similar to that shown in FIG. 3A. It should be pointed out though that the invention is not limited to the data structure shown in FIGS. 3A and 3B.

FIG. 2 shows a schematic diagram of the structure of one of the network components 11-16 used in FIG. 1 according to the preferred embodiment.

In addition to the first interface 61 and the second interface 62, the first network component 11 shown in FIG. 2 comprises a memory interface 43, a decrypter 51, a data selector 52, an encrypter 53, a second memory facility 42, a first identification system 71 and a management facility 54 with a third interface 63. Alternatively, the management facility may have no interface of its own and access interface 62 instead.

The network component 11 in FIG. 2 further comprises auxiliary systems not shown here such as a power supply and a display or one or several control lamps to indicate its operating state. An additional controller may superimpose the components of network component 11 shown in FIG. 2. The components are interconnected by data lines. They are housed in a casing 10.

The first memory facility 41 in the area shown is not a permanent component of the network component 11 but can be detachably connected to it via the memory interface. A second identification system 72 is integrated into the first memory facility 41.

The decrypter 51, the data selector 52, the encrypter 53, the first identification system 71, and the second identification system 72 are microprocessors set up with a suitable software complement. These microprocessors comprise an operating system that is different from the operating system of the assigned first communication interface 31.

The first and second interfaces 61, 62 in FIG. 2 each are Ethernet interfaces.

Alternatively, the first interface 61 may for example be a PCMCIA interface or the like, and the second interface 62 may be a WLAN or ISDN interface or the like. The only requirement is that the first interface 61 enables a connection to the assigned communication interface 31 and the second interface 62 enables a connection to the transmission network 20.

The network component 11 receives or sends data from/to the assigned first communication interface 31 or the transmission network 20 via the first interface 61 and the second interface 62.

The network component 11 is designed in a way that the communication address of the assigned first communication interface 31 (network card of the personal computer) is visible to the transmission network 20 and the data output by the communication interface 31 is previously processed so that the processed data is encoded according to the protocol used by the transmission network 20.

In the embodiment shown, the first memory facility 41 is a removable non-volatile storage medium in the form of a USB token 41. Accordingly, the memory interface 43 is a USB interface 43 for the USB token 41. Alternatively, the first memory facility 41 may for example be a disc, a compact disc (CD), a digital versatile disc (DVD), a smart card, and the memory interface is matched accordingly.

The second identification system 72 incorporated in the USB token 41 is used to verify a user's identity and comprises a sensor for capturing biometric data (not shown). The second identification system 72 grants access to data stored on the USB token 41 only after the successful identification of a user.

The USB token 41 stores the preset coding keys K1 and K3 as well as the key identifiers that denote the coding keys K1, K3. These key identifiers are different from the communication addresses used for addressing a respective communication interface 31-37. A communication address and/or a storage medium ID and/or a network component ID may be assigned to each key identifier. Furthermore, metadata on the coding keys K1, K3 is stored on the USB token that contain information on the way in which the respective coding keys K1 and K3 are used. The metadata are assigned to a key identifier of a coding key K1, K3.

Furthermore, a unique storage medium ID is stored in the USB token.

Although symmetrical coding keys are preferred, asymmetrical coding keys may be used as well.

The second memory facility 42 is a non-volatile memory permanently integrated into the network component 11 in which specifications of the transmission protocols used by the transmission network 20 of the communication network 1. In addition, a unique network component ID that is stored in the second memory facility 42 is assigned to the network component 11. In the embodiment shown, the second memory facility 42 is a FLASH memory.

Alternatively or in addition, coding keys and key identifiers denoting them can be stored in the second memory facility 42. This facilitates autonomous operation of the network component according to the invention. In this case, the first memory facility may be fully incorporated in the second memory facility.

The encrypter 53 is designed to encrypt data that is received by the assigned first communication interface 31 via the first interface 61. The encrypter 53 uses one of the coding keys K1, K3 stored in the first and/or second memory facility 41.

Prior to encryption, the encrypter 53 reads a storage medium ID via the USB interface 43 from the USB token 41 and a network component ID from the second memory facility 42 and adds it optionally to the data to be encrypted. The encrypter 53 also automatically calculates a check value for the data to be encrypted prior to encryption and adds this calculated check value to the data to be encrypted.

To select a coding key K1, K3 suitable for data exchange, the encrypter 53 reads specifications of transmission protocols from the second memory facility 42 and automatically detects a protocol data part that can only be put down to the transmission protocol used and a user data part containing the remaining data in the data to be encrypted. The encrypter 53 automatically detects a communication address used for addressing a respective addressed communication interface 32-37 in the protocol data part and searches in the first memory facility 41 for a key identifier assigned to this communication address. If a key identifier assigned to this communication address is stored in the first memory facility 41, the encrypter 53 encrypts the use data part using the coding key K1 or K3 associated with this key identifier and automatically adds the respective key identifier of the coding key K1, K3 used unencrypted to the encrypted use data part.

To prevent that the coding keys K1, K2, K3 used by the encrypter 53 can be determined by analysis of encrypted data, the encrypter 53 automatically adds random data to a data section of the use data to be encrypted and encrypts this data along with the use data. The encrypter 53 labels the data section filled with the random data in the use data part. The addition of random data ensures that identical data encrypted with the same coding key and the same encryption algorithm will result in different data. It is thus impossible or considerably more difficult to determine the coding key used by analyzing encrypted data.

After the encryption, the encrypter 53 may optionally add the unencrypted storage medium ID and network component ID read. The encrypter 53 automatically creates a new protocol data part for the encrypted use data part using the specifications read and the detected protocol data part. The encrypter 53 uses the identified communication address of the addressed communication interface 32-37 and creates the new protocol data part for the encrypted use data part while retaining the identified communication address.

If no key identifier is stored in the first memory facility 41 that is assigned to the communication address, the encrypter 53 automatically transmits unencrypted use data that specify all key identifiers stored in the first memory facility 41 via the second interface 62 and the transmission network 20 to a respective addressed communication interface 32-37.

If there are various coding keys that can be used for an encryption, the encrypter 53 automatically uses the coding key K1, K3 stored in the USB token 41 that promises the most secure encryption (e.g. the longest coding key).

The decrypter 51 is designed for decrypting the encrypted data received from the transmission network 20 via a second interface 62. To do this, the decrypter 51 reads specifications of transmission protocols from the second memory facility 42 and detects an unencrypted protocol data part and an encrypted use data part in the encrypted data using these specifications. Furthermore, the decrypter 51 automatically identifies the key identifier that denotes the coding key K1, K3 used in the encrypted data received. Then the decrypter 51 decrypts the encrypted use data part using the at least one coding key K1, K3 that is denoted by the identified key identifier.

The decrypter 51 is also designed to automatically identify a check value in the encrypted or decrypted data, to calculate a check sum for the data decrypted using the at least one coding key K1, K3, and to calculate the encrypted data and compare the check sum with the check value. If the check sum matches the check value, the decrypter 51 automatically identifies a communication address used in the transmission network 20 for addressing a respective transmitting communication interface 32-37 in the detected protocol data part and assigns this communication address to the key identifier stored in the USB token for the coding key K1, K3 used for decryption. Optionally, the decrypter 51 can read a storage medium ID and network component ID from the detected use data part and additionally assign this ID to the key identifier of the coding key K1, K3 used.

The decrypter 51 automatically detects a communication address used in the transmission network 20 for addressing a respective addressed communication interface 32-37 and creates a new protocol data part for the decrypted use data part while retaining the detected communication address.

If no key information is identified in the encrypted data received, the decrypter 51 automatically identifies the communication address used for addressing a respective transmitting communication interface 32-37 in the detected protocol data part or a storage medium ID or network component ID in the detected use data part, and searches in the USB token or internal memory 42 for a key identifier assigned to this communication address or storage medium ID or network component ID. If an assigned key identifier exists, the decrypter 51 uses the respective coding key K1, K3 for decrypting the use data part of the encrypted data.

Alternatively, the decrypter 51 may try decryption using all coding keys stored in the USB token 41 or the internal memory 42.

However, if the decrypter 51 receives unencrypted user data via the second interface 62 from the transmission network 20 that specifies multiple key identifiers, the decrypter 51 automatically compares the specified key identifiers with all key identifiers stored in the USB token 41 or internal memory 42 and identifies the communication address used for addressing a respective transmitting communication interface 32-37 in the detected protocol data part associated with the user data received. Then the decrypter 51 sends unencrypted use data containing all common key identifiers and optionally the storage medium ID of the USB token 41 and/or the network component ID of the network component 11 via the second interface 62 and the transmission network 20 to the respective transmitting communication interface 32-37.

If the decrypter 51 receives unencrypted use data containing common key identifiers via the second interface 62 from the transmission network 20, the decrypter 51 automatically identifies the communication address used for addressing a respective transmitting communication interface 32-37 in the protocol data part associated with the use data received and assigns it to the common key identifiers stored in the USB token 41. The decrypter 51 may optionally read a storage medium ID or network component ID from the detected use data part and assign it to the key identifiers stored in the USB token 41.

The data selector 52 is used for selective data transfer between the transmission network 20 and the assigned first communication interface 31. For this purpose, the data selector 52 is connected to the first and second interfaces 61 and 62, the encrypter 53, the decrypter 51, and the first identification system 71.

The data selector 52 automatically prevents forwarding of encrypted data received via the second interface 62 to the first communication interface 31 if the encrypted data cannot be decrypted by the decrypter 51 using the at least one coding key K1, K3. Accordingly, the data selector 52 automatically forwards encrypted data to the assigned first communication interface 31 after successful decryption by the decrypter 51. The data selector 52 evaluates if decryption was successful by comparing the check sum calculated by the decrypter 51 from the encrypted use data with the check value detected by the decrypter 51 in the decrypted data. Check sum and check value must match for decryption to be successful.

To effectively prevent unauthorized access by a third party to the assigned first communication interface 31, the data selector 52 generally blocks the transfer of unencrypted data received via the transmission network 20 to the first communication interface 31.

The data selector 52 also ensures that data received from the assigned first communication interface 31 is output to the transmission network 20 only after encryption by the encrypter 53 using the at least one coding key K1 K3.

The management facility 54 can be used to adjust the settings of the components of the network component 11. The management facility 54 comprises a third interface 63 via which the management facility 54 is connected to the transmission network 20 to exchange management data, and a communication address that can be addressed via the transmission network 20 is assigned to the management facility 54. The communication address of the management facility 54 is different from the communication address of the assigned first communication interface 31. In this way, the network component 11 of the invention can be subjected to status monitoring and maintenance operations and optionally be remote controlled. It is also possible to manipulate the data stored in the USB token 41 connected to the USB interface 43 and/or the second memory facility 42 using the management facility 54. In this way, the management facility 54 can optionally reset the network components 11 to a delivery status (reset function). To ensure a sufficient security level, the management facility 54 only receives and sends data encrypted using a special preset coding key. The special preset coding key of the management facility 54 can be stored directly in the management facility 54 or in the second memory facility 42.

The management facility 54 regularly reads out data stored in the USB token 41 that is connected to the USB interface 43. If specially encoded management commands are stored in the USB token, the management facility 54 will execute these commands automatically.

The first identification system 71 is permanently incorporated into the network component 11 and is used to verify a user's identity. For this purpose the first identification system 71 comprises a keyboard (not shown) for entering a personal identification code in the embodiment shown here. The first identification system 71 ensures that the USB token 41 connected to the USB interface 43 and the second memory facility 42 can only be read after a user has been successfully identified. Successful identification by the first identification system 71 is also required for access to the decrypter 51, the data selector 52 or the encrypter 53 from the management system 54.

The preferred embodiment described above uses a transmission network 20 in which a protocol data part and a user data part of the data (as shown in FIG. 3A) are transferred jointly. Alternatively, a transmission network 20 may be used in which a protocol data part and a use data part of the data (as shown in FIG. 3B) are transferred via separate channels. In this case the decrypter 51 or encrypter 53 receive the unencrypted protocol data part via a first channel of the transmission network and an encrypted use data part via a second channel that is different from the first channel of the transmission network. It is therefore not required to detect the protocol data part and user data part using a specification of the transmission protocol. The protocol data part and the user data part are then processed by the decrypter 51 or the encrypter 53 as described above.

The decrypter 51, encrypter 53, data selector 52, the first identification system 71, and the management facility 54 are separate components in the preferred embodiment. Alternatively, these components can be integrated into a common microprocessor. In this case, it is preferred that an operating system of the microprocessor is different from an operating system of the assigned communication interface 31.

Furthermore, the decrypter 51, the encrypter 53, the data selector 52, the first identification system 71, the USB interface 43, the second memory facility 42, and the management facility 54 of the embodiment shown in FIG. 2 are connected via individual data lines. Alternatively, these components of the network component 11 may also be connected by a common data bus.

The other network components 12-16 of the communication network 1 shown in FIG. 1 have the same structure as the network component 11 described above.

Due to the preset coding keys K1 and K3 stored in the USB token 41 connected to the first network component 11, data can be exchanged with the second to seventh communication interfaces 32-37 as the associated second to sixth network components 12-16 each comprise one of the coding keys K1 and/or K3.

Data exchange between the third communication interface 33 and the fourth communication interface 34 would for example not be possible in the example shown in FIG. 1 because the associated third and fourth network components 13 and 14 do not have a common coding key. Neither can data be exchanged with the eighth and ninth communication interfaces as these do not have a network component and can therefore not transmit or receive data encrypted with a preset coding key.

Thus the network components 11-16 of the invention superimpose a network of encrypted secure data connections between the communication interfaces 31-37 assigned to the network components 11-16 on the transmission network 20. The network structure, i.e. the decision which communication interfaces 31-37 can exchange data via the transmission network 20 solely depends on the respective coding keys K1, K2, K3 stored in the assigned network components 11-16. Intervention by the user beyond providing the coding keys is not required for the network architecture.

The data exchange between communication interfaces 31-37 can be controlled in a particularly simple, flexible, and secure manner by suitably distributing first memory facilities 41 with coding keys K1, K2, K3 stored therein to authorized persons. For example, work groups that have specific mutual access rights can be defined dynamically.

Even if only three coding keys K1, K2, K3 are stored in the first memory facilities 41 of the network components 11-16 in the example described above, it is obvious for an expert skilled in the art that any number of coding keys can be used.

It is also possible to provide external access to a secondary network using the network components 11-16 of the invention. Network components 11-16 according to the invention are provided at access points/dialup systems of a dialup network corresponding to the transmission network. Each network component 11-16 is equipped with a removable storage medium with at least one stored preset coding key. A network component 11-16 according to the invention with a respective coding key is also placed between a server enabling access to the secondary network and the dialup network. By the matching of the coding keys, it can be controlled which communication interfaces 31-37 that are or can be connected to the network components 11-16 are allowed access to the server and thus to the secondary network. Unique storage medium IDs of the removable storage media can be read to assign access to a user (such as for billing purposes).

A description of a preferred embodiment of the method according to the invention for providing a data connection among at least two communication interfaces 31, 32, 33, 34, 35, 36, 37 that can be connected via a transmission network 20 is given below with reference to the FIGS. 4A and 4B.

The embodiment is described using the example of providing a data connection between the two second and fourth communication interfaces 32 and 34 connected via the transmission network 20. Second or fourth network components 12 or 14, respectively, are provided among the communication interfaces 32, 34 and the transmission network 20.

The following refers to FIG. 4A.

The fourth communication interface 34 outputs data (for example as a result of a user input) that is to be transferred to the second communication interface 32 via the transmission network 20 to provide a data connection. The fourth communication interface 34 automatically encodes the data to be transferred so that it complies with a transmission protocol used in the transmission network 20. This means that the data to be transferred comprises for example a protocol data part that contains a communication address of the addressed second communication interface 32.

As the fourth network component 14 is placed between the communication interface 34 and the transmission network 20, it receives the data to be transferred from the fourth communication interface 34 in a first step (S1).

Subsequently, a transmission protocol used in the transmission network is identified automatically based on the received data to be transferred and using specifications of known transmission protocols (S2). The simplest way to do this is by determining a packet size.

Then a protocol data part that can merely be put down to the transmission protocol used and a use data part containing the actual use data are detected automatically in the data to be transferred (S3).

The component then automatically identifies a communication address used for addressing the second (addressed) communication interface 12 in the detected protocol data part (S4) and searches for a key identifier assigned to this communication address (S5). It can for example search a database in which information on past successful data connections is stored. It is assumed in the case on hand that a key identifier that denotes the coding key K3 is assigned to the addressed communication address.

Subsequently, a check value for the data to be transferred is calculated automatically (S6) and added to the data to be transferred (S7). The check value is preferably calculated in such a way from the data to be transferred that the integrity of the data can be verified.

Then the user data part of the data to be transferred is encrypted automatically using coding key K3 that is assigned to this key identifier and a known encryption algorithm (S8), and a key identifier denoting the coding key K3 used for encryption is added unencrypted to the encrypted use data part (S9).

According to an alternative embodiment, the method may additionally include the steps of identifying a communication address used in the transmission network 20 for addressing the transmitting fourth communication interface 34 in the detected protocol data part and/or identifying a storage medium ID or network component ID in the detected use data part. After successful identification, the identified communication address or the identified storage medium ID or network component ID is assigned to a key identifier that denotes the coding key K3 used for decryption. This makes it possible to automatically select a suitable coding key K1, K2, K3 for encryption when data connections are to be provided later on between the fourth and second communication interfaces 32, 34.

The data encrypted in this way are automatically output to the transmission network 20 (S10).

The output of the encrypted data includes the automatic creation of a new protocol data part for the encrypted user data part using the specification of the identified transmission protocol and the detected protocol data part to create encrypted data that complies with the identified transmission protocol. It is preferred that the detected communication address is kept when creating the new protocol data part.

The above steps S1-S10 of the method are performed by the fourth network component 14.

The transmission network 20 automatically transmits the data using the communication address and the respective transmission protocol to the second communication interface 32. As the second network component 12 is located between the second communication interface 32 and the transmission network 20, the second communication interface 32 does not receive the transmitted data directly but via the second network component 12. It is required for this purpose that the second network component 12 is transparent from the point of view of the transmission network 20.

In FIG. 4B, it first is the second network component 12 that receives encrypted data (S11).

The key information is then identified automatically in the encrypted data received (S12). In this example, the key information is the key identifier that denotes the coding key K3 used for encryption and that was added to the encrypted data in step (S9). The key information can therefore simply be read from the encrypted data.

If the identified key information denotes a known coding key K3, the encrypted data received is automatically decrypted using this coding key K3 (S13).

If such key information is not contained in the encrypted data received or cannot be identified, the method according to an alternative embodiment may further include the steps of identifying a communication address used for addressing a respective transmitting (fourth) communication interface 34 in a protocol data part detected using specifications of transmission protocols and of searching for the key identifier assigned to this communication address. If a key identifier is assigned to this communication address, the coding key K3 assigned to this key identifier is used for subsequent decryption of the data.

Alternatively, all known coding keys may be tried.

Then the method checks in step (S14) if the encrypted data really can be decrypted using coding key K3.

If not, transfer of the data received from the transmission network 20 to the second communication interface is automatically prevented (S19).

Otherwise a check sum of the decrypted data is calculated automatically (S16), and the check value added to the data received is identified (S15).

The subsequent step (S17) verifies if the calculated check sum matches the check value identified in the data received.

If there is a match, the decrypted data is automatically forwarded to the assigned second communication interface 34 (S18) and a data connection established in this way between the fourth and second communication interfaces 14, 12.

Forwarding the decrypted data includes the automatic creation of a new protocol data part for the decrypted user data part using the specification of the identified transmission protocol and a detected protocol data part to the data to be decrypted and the creation of decrypted data that complies with the identified transmission protocol from the new protocol data part and the decrypted user data part. It is preferred that the detected communication address is kept when creating the new protocol data part for the decrypted use data part.

Otherwise, transfer of the data received from the transmission network 20 to the second communication interface 32 is prevented automatically (S19).

In this example, steps (S11)-(S19) of the method are performed by the second network component 12.

It is pointed out that the sequence of steps described above may be altered. In addition, some steps such as the use of the check value and the identification of the transmission protocol or the key information are just optional.

Even if the check value for the data to be encrypted was calculated and added to the unencrypted data, the check value may alternatively to steps (S6), (S7) be calculated for the encrypted data and added to the encrypted data. Accordingly, identification of the check value and calculation of the check sum between steps (S8) and (S10) may also be performed on the data when still encrypted.

It may further be advantageous if, in step (S11) of receiving unencrypted data transmitted, for example, from the eighth or ninth communication interface 38, 39 via the transmission network 20 by the second network component 12, the method according to the invention includes the steps of automatic recognition that the data is not encrypted using a preset coding key K1, K3 and of preventing transfer of the unencrypted data received to the at least one assigned second communication interface 32 by the second network component 12.

To keep the effort required for performing the method according to the invention down, it may further be advantageous if in steps (S8) and (S13) only the use data part is encrypted or decrypted using the at least one coding key K1, K3.

The example of a preferred embodiment of the method according to the invention was based on the assumption that, in steps (S2)-(S5), a key identifier is assigned to a communication address used for addressing a respective addressed (second) communication interface 32 and that this key identifier can be used to determine a suitable coding key K3 for the encryption of the data.

To be able to provide a data connection to the second communication interface 32 if its communication address has not yet been assigned a key identifier, the method of the invention, according to a first approach, comprises the steps of encrypting preset test data using any preset coding key K3 and transmitting the encrypted test data to the addressed second communication interface 32.

The transmission protocols of many transmission networks 20 provide that communication interfaces 31-39 automatically acknowledge receipt of data by sending an acknowledgement of receipt via the transmission network to the respective transmitting communication interface 31-39. If this does not apply with a transmission protocol used, this can be caused automatically by respective preset test data.

If such acknowledgement of receipt is received as a result of sending the encrypted test data, this proves that a (second) network component 12 assigned to a receiving (second) communication interface 32 also has the coding key K3 used for encryption. This coding key K3 can therefore be used to provide a data connection.

A second approach to providing a data connection if no key identifier is assigned to the communication address used for addressing the respective addressed communication interface 31-37 is described below. As a variation of the example described above, a data connection is to be provided among the first as well as the sixth and seventh communication interfaces 31 as well as 36 and 37 shown in FIG. 1.

In this case, the first network component 11 of the first communication interface 31 automatically creates unencrypted user data that specify key identifiers denoting the coding keys K1 and K3 known to the first network component 11. These unencrypted user data are transferred by the first network component 11 with a first communication address specifying communication interface 31 as sender via the transmission network 20 to the sixth and seventh communication interfaces 36 and 37.

The sixth network component 16 placed upstream of the sixth and seventh communication interfaces 36 and 37 receives the unencrypted use data.

The sixth network component 16 automatically determines that unencrypted data was received via the transmission network 20 which specifies multiple key identifiers and compares the multiple key identifiers of coding keys K1, K3 specified with the key identifier that denotes the preset coding key K1 that is known to the sixth network component 16. Then the sixth network component 16 automatically identifies a communication address used for addressing the transmitting communication interface 31 in a protocol data part associated with the unencrypted use data received and creates unencrypted use data that specifies the common key identifier of common coding key K1. These unencrypted user data are transmitted by the sixth network component 16 with the communication addresses that identify the assigned sixth and seventh communication interfaces 36 and 37 as senders via the transmission network 20 to the first communication interface 31.

The first network component 11 located upstream of the first interface 31 receives the unencrypted use data and automatically determines that use data specifying common key identifiers was received. As a result, the first network component 11 automatically identifies the communication addresses used for addressing the transmitting sixth and seventh communication interfaces 36 and 37 in the protocol data part of the unencrypted use data received and assigns the common key identifier of the common coding key K1 to the identified communication addresses. This assignment enables the establishment of a data connection between the first and the sixth and seventh communication interfaces 31, 36, 37.

The preferred embodiment described above was based on the assumption that the data transfer via a transmission network 20 is performed via one channel using data consisting of a protocol data part and a user data part. The method of the invention may however be applied as well to transmission networks in which the transfer of a protocol data part and a user data part is performed separately, particularly (though not exclusively) using different channels of the transmission network.

In this case, the method according to the invention preferably comprises the steps of receiving an unencrypted protocol data part via the first channel, said protocol data part specifying a communication address used in the respective transmission network for addressing a respective communication interface and of receiving an encrypted or unencrypted use data part via the second channel, said use data part containing data to be transferred between the communication interfaces.

Accordingly, a communication address of a transmitting and/or receiving communication interface can be identified directly in the protocol data part received and used in the method described above. Accordingly, the user data part received via the second channel can be decrypted or encrypted using the at least one preset coding key.

To increase the security level of the method according to the invention for providing a data connection even further, additional steps of verifying a user's identity and of comparing a determined user identity with the identities of approved users can be provided. In this case, the steps of encrypting or decrypting using the at least one preset coding key K1, K2, K3 are only performed if the verified identity is assigned to an approved user. In this way, the method according to the invention can ensure that data connections are only provided for a preset group of users.

The method according to the invention described above can advantageously be performed using the network component 11 of the invention described above in the communication network 1 of the invention described above.

To summarize, the network component of the invention, the communication network of the invention, and the method of the invention for providing a data connection facilitate a particularly simple and reliable way of securely exchanging data among at least two communication interfaces connected via a transmission network without requiring any user intervention. At the same time, access by an unauthorized party to a communication interface connected to the transmission network via the transmission is made considerably more difficult.

1. A network component (11, 12, 13, 14, 15, 16) for a communication network (1) in which multiple communication interfaces (31, 32, 33, 34, 35, 36, 37) are interconnected via a transmission network (20) for mutual data exchange,
wherein said network component (11, 12, 13, 14, 15, 16) can be placed between at least one assigned communication interface (31-37) and the transmission network (20),
characterized in that the network component (11-16) comprises:
a first memory facility (41) for storing at least one preset coding key (K1, K2, K3),
a decrypter (51) for decrypting encrypted data received via the transmission network (20) using the at least one stored coding key (K1, K2, K3), and
a data selector (52) for the selective transfer of data between the transmission network (20) and the at least one assigned communication interface (31-37), said data selector (52) being designed to automatically prevent transfer of encrypted data received via the transmission network (20) to the at least one assigned communication interface (31-37) if the decrypter (51) cannot decrypt the encrypted data using the at least one coding key (K1, K2, K3).

2. The network component (11-16) according to claim 1,
wherein the data selector (52) is designed to automatically forward encrypted data received via the transmission network (20) to the at least one assigned communication interface (31-37) after decryption by the decrypter (51) using the at least one coding key (K1, K2, K3).

3. The network component (11-16) according to claim 1 or 2,
wherein the network component (11-16) comprises a first interface (61) for connecting the network component (11-16) to the at least one assigned communication interface (31-37) and a second interface (62) for connecting the network component (11-16) to the transmission network (20), said first interface (61) being connected to the data selector (52) and said second interface (62) being connected to the decrypter (51).

4. The network component (11-16) according to any one of claims 1 through 3,
wherein the decrypter (51) is further designed to automatically identify of key information that denotes a coding key (K1, K2, K3) used for encryption in the encrypted data received via the transmission network (20).

5. The network component (11-16) according to claim 4,
wherein the key information is a key identifier that is added in unencrypted form to the encrypted data received via the transmission network (20).

6. The network component (11-16) according to claim 4 or 5,
wherein a communication address is assigned to each of the communication interfaces (31-37) of the transmission network for addressing in conjunction with the mutual data exchange, and
wherein the key information is different from the communication address used for addressing a respective communication interface (31-37).

7. The network component (11-16) according to any one of claims 1 through 6,
wherein the network component (11-16) further comprises:
an encrypter (53) for encrypting data received from the assigned communication interface (31-37) using the at least one stored coding key (K1, K2, K3), wherein the data selector (52) is designed to automatically output data received from the assigned communication interface (31-37) to the transmission network (20) only after encryption by the encrypter (53) using the at least one coding key (K1, K2, K3).

8. The network component (11-16) according to claim 7 wherein a key identifier denoting the coding key (K1, K2, K3) is stored in the first memory facility (41) for the at least one preset coding key (K1, K2, K3), and
wherein the encrypter (53) is designed to automatically add the respective key identifier of the coding key (K1, K2, K3) used in unencrypted form to the data encrypted using the at least one coding key (K1, K2, K3) after the encryption.

9. The network component (11-16) according to any one of claims 7 or 8,
wherein the encrypter (53) is designed to automatically calculate a check value for the data to be encrypted or the encrypted data received from the assigned communication interface (31-37) and to add the calculated check value to the data to be encrypted prior to encryption or to the encrypted data after the encryption.

10. The network component (11-16) according to any one of claims 1 through 9,
wherein the decrypter (51) is designed to automatically identify a check value in the encrypted or decrypted data, to calculate a check sum for the data decrypted using the at least one coding key (K1, K2, K3) or the encrypted data, or to calculate the encrypted data and to compare the check sum with the check value, and
wherein the data selector (52) is designed to automatically prevent a transfer of decrypted data to the at least one assigned communication interface (31-37) if the check sum does not match the check value.

11. The network component (11-16) according to any one of claims 1 through 10,
wherein the data selector (52) is designed to automatically prevent the transfer of unencrypted data received via the transmission network (20) to the at least one assigned communication interface (31-37).

12. The network component (11-16) according to any one of claims 1 through 11,
wherein the network component (11-16) comprises a second memory facility (42) that is permanently integrated into the network component (11-16) and in which at least one specification of a transmission protocol used in the communication network (1) is stored, and
wherein the decrypter (51) is designed to use the stored specifications to detect an unencrypted protocol data part that can only be put down to the respective transmission protocol used and an encrypted user data part containing the remaining data in the encrypted data received via the transmission network (20), and to use the at least one coding key (K1, K2, K3) to decrypt only the encrypted user data part.

13. The network component (11-16) according to claim 12, wherein the decrypter (51) is designed to automatically create a new protocol data part for the decrypted user data part using the stored specifications and the detected protocol data part.

14. The network component (11-16) according to claim 13, wherein the decrypter (51) is designed to automatically identify a communication address used in the transmission network (20) for addressing a respective addressed communication interface (31-37) in the detected protocol data part and to create the new protocol data part for the decrypted use data part while retaining the detected communication address.

15. The network component (11-16) according to any one of claims 1 through 11, wherein the decrypter (51) is designed
to receive an unencrypted protocol data part via a first channel of the transmission network, said protocol data part specifying a communication address used in the respective transmission network (20) for addressing a respective communication interface (31-37),
to receive an encrypted user data part that contains the data to be transferred among the communication interfaces (31-37) via a second channel of the transmission network that is different from the first channel of the transmission network, and
to decrypt only the encrypted user data part using the at least one coding key (K1, K2, K3).

16. The network component (11-16) according to any one of claims 12 through 15,
wherein the decrypter (51) is designed to automatically identify a communication address used in the transmission network (20) for addressing a respective transmitting communication interface (31-37) in the protocol data part detected or received via the first channel and to store it together with a key identifier that denotes the coding key (K1, K2, K3) used for decryption in the first and/or second memory facility (42).

17. The network component (11-16) according to claim 16 wherein the decrypter (51) is designed to automatically identify the communication address used for addressing a respective transmitting communication interface (31-37) in the protocol data part detected or received via the first channel, to search for a key identifier assigned to this communication address in the first and/or second memory facility (42), or to identify a key information in the user data part and to use the respective coding key (K1, K2, K3) assigned to this key identifier or key information for decrypting the encrypted user data part.

18. The network component (11-16) according to claim 16, wherein the encrypter (53) is designed to automatically identify a communication address used for addressing a respective addressed communication interface (31-37) in the protocol data part detected or received via the first channel, to search for a key identifier assigned to this communication address in the first and/or second memory facility (42), and to use coding key (K1, K2, K3) denoted by the respective the key identifier for encrypting the data.

19. The network component (11-16) according to claim 18, wherein the encrypter (53) is designed to automatically encrypt preset test data using any preset coding key (K1, K2, K3) stored in the first and/or second memory facility (41, 42) and send it via the transmission network (20) to a respective addressed communication interface (31-37) if no key identifier assigned to a communication address used for addressing the respective addressed communication interface (31-37) is stored in the first and/or second memory facility (41, 42).

20. The network component (11-16) according to claim 18, wherein the encrypter (53) is designed to automatically send unencrypted user data that specify all key identifiers stored in the first and/or second memory facility (41, 42) of the network component (11-16) or a subset thereof via the transmission network (20) to a respective addressed communication interface (31-37) if no key identifier assigned to the communication address used for addressing the respective addressed communication interface (31-37) is stored in the first and/or second memory facility (41, 42).

21. The network component (11-16) according to claim 20 wherein the decrypter (51) is designed, when receiving unencrypted user data specifying multiple key identifiers via the transmission network (20), to automatically compare the specified key identifiers to all key identifiers stored in the first and/or second memory facility (41, 42) of the network component (11-16), to identify the communication address used for addressing of a respective transmitting communication interface (31-37) in the protocol data part associated with the received user data which protocol data part is detected or received via the first channel, and to send unencrypted user data containing all common key identifiers via the transmission network (20) to the respective transmitting communication interface (31-37).

22. The network component (11-16) according to claim 21, wherein the decrypter (51) is designed, when receiving unencrypted user data specifying common key identifiers via the transmission network (20), to automatically identify the communication address used for addressing the respective transmitting communication interface (31-37) in the protocol data part associated with the use data received and either detected or received via the first channel, and to store it together with the common key identifiers in the first and/or second memory facility (41, 42).

23. The network component (11-16) according to any one of claims 12 through 14,
wherein the encrypter (53) is designed to automatically detect a protocol data part that can only be put down to the respective transmission protocol used and a user data part containing the remaining data in the data received from the at least one assigned communication interface (31-37) using the stored specifications and to encrypt only the user data part using the at least one coding key (K1, K2, K3).

24. The network component (11-16) according to claim 23, wherein the decrypter (53) is designed to automatically create a new protocol data part for the encrypted use data part using the stored specifications and the detected protocol data part.

25. The network component (11-16) according to claim 24, wherein the decrypter (53) is designed to automatically identify a communication address used in the transmission network (20) for addressing a respective addressed communication interface (31-37) in the detected protocol data part and to create the new protocol data part for the encrypted user data part while retaining the detected communication address.

26. The network component (11-16) according to any one of claims 1 through 25,
wherein the first memory facility (41) and/or the second memory facility (42) is a non-volatile memory that is permanently integrated into the network component (11-16).

27. The network component (11-16) according to any one of claims 1 through 26,
wherein the network component (11-16) comprises a management facility (54) that is designed to adjust the settings of the network component (11-16).

28. The network component (11-16) according to claim 27, wherein a communication address that can be addressed via the transmission network (20) is assigned to the management facility (54) and the management facility (54) is connected to the transmission network (20) for exchanging management data.

29. The network component (11-16) according to any one of claims 26 through 28,
wherein the network component (11-16) comprises a first identification system (71) for verifying a user's identity, and
wherein the first identification system (71) permits reading of the memory and/or a management system activity only after a user's successful identification.

30. The network component (11-16) according to any one of claims 1 through 29,
wherein the first memory facility (41) is a removable non-volatile storage medium,
the network component (11-16) comprises a memory interface (43) for the removable storage medium, and the second memory facility (42) is a non-volatile memory permanently integrated into the network component (11-16).

31. The network component (11-16) according to claim 30 wherein the removable storage medium is a diskette, a compact disk (CD), a digital versatile disk (DVD), a smart card, or a USB token.

32. The network component (11-16) according to claim 30 or 31,
wherein the removable storage medium comprises a second identification system (72) for verifying a user's identity, and
wherein the second identification system (72) permits reading of the removable storage medium only after a user's successful identification.

33. The network component (11-16) according to any one of claims 30 through 32,
wherein a unique storage medium ID is assigned to the removable storage medium, and
wherein the encrypter (53) is designed to automatically read out the storage medium ID of a removable storage medium connected to the network component (11-16) via the memory interface (43) for the removable storage medium and to add the storage medium ID read out to the data to be encrypted or to the encrypted data.

34. The network component (11-16) according to claim 29 or 32,
wherein the first and/or second identification system (71, 72) comprises a keyboard for entering a personal identification code and/or a sensor for capturing biometric data.

35. The network component (11-16) according to any one of claims 7 through 34,
wherein a unique network component ID is assigned to the network component (11-16), and
wherein the encrypter (53) is designed to automatically read out the network component ID and to add the network component ID of the network component (11-16) to the data to be encrypted.

36. The network component (11-16) according to any one of claims 1 through 35,
wherein metadata are assigned to the coding keys stored in the first memory facility (41) and said metadata contain information on the way in which the respective coding key (K1, K2, K3) is used and/or metadata are stored in the second memory facility (42) that is assigned to a key identifier of a coding key (K1, K2, K3).

37. The network component (11-16) according to any one of claims 1 through 36,
wherein the decrypter (51), the encrypter (53), the data selector (52) and preferably the management facility (54) are integrated into a microprocessor.

38. The network component (11-16) according to claim 37, wherein the microprocessor comprises an operating system that is different from an operating system of the at least one assigned communication interface (31-37).

39. A communication network (1), comprising
a transmission network (20) enabling data exchange and multiple communication interfaces (31, 32, 33, 34, 35, 36, 37) connected to the transmission network (20), wherein the communication interfaces (31-37) are designed for data exchange via the transmission network (20),
wherein the communication network (1) further comprises at least two network components (11, 12, 13, 14, 15, 16) with the characteristics of claims 1 through 38 and the network components (11-16) are assigned to at least one communication interface (31-37) and placed between the respective assigned communication interface (31-37) and the transmission network (20).

40. The communication network (1) according to claim 39, wherein at least one of the at least two network components (11-16) is placed between multiple communication interfaces (31-37) assigned to this network component (11-16) and the transmission network (20).

41. The communication network (1) according to claim 39 or 40,
wherein a unique communication address is assigned to each of the communication interfaces (31-37) for addressing purposes in conjunction with the mutual data exchange, and
wherein the network components (11-16) are designed so that the respective communication address of the assigned communication interface (31-37) is visible to the transmission network (20).

42. The communication network (1) according to claim 39, 40, or 41,
wherein the communication interfaces (31-37) are designed to encode data to be transferred according to a transmission protocol used by the respective transmission network (20) before the data is output to the associated network component (11-16), and wherein the network components (11-16) are designed to process the data received from the respective associated communication interface (31-37) so that the processed data are also encoded according to the protocol used by the transmission network (20).

43. The communication network (1) according to any one of claims 39 through 42,
wherein a communication address is assigned to each communication interface (31-37), and
wherein the transmission network (20) comprises switches and/or routers which use the communication address to purposefully provide transmission paths among the communication interfaces (31-37).

44. The communication network (1) according to any one of claims 39 through 43,
wherein the transmission network (20) provides an IEEE802.3 Ethernet connection or an IEEE802.11 wireless LAN connection or an ISDN connection or a GSM connection or an UMTS connection or a TCP/IP connection between the communication interfaces (31-37).

45. The communication network (1) according to any one of claims 39 through 44,
wherein the network component (11-16) is a device that is separate from the respective assigned communication interface (31-37).

46. A method of providing a data connection between at least two communication interfaces (31, 32, 33, 34, 35, 36, 37) that can be connected via a transmission network (20), wherein a network component (11, 12, 13, 14, 15, 16) is provided between at least two of the communication interfaces (31-37) and the transmission network (20), comprising the following steps:
(S11) receiving encrypted data sent by a communication interface (31-37) via the transmission network (20) by the respective network component (11-16) before the data is output to the respective communication interface (31-37);
(S13) decrypting the encrypted data received using at least one preset coding key (K1, K2, K3); and
(S18) forwarding the decrypted data by the network component (11-16) to the respective communication interface (31-37) for providing a data connection if the encrypted data can be decrypted using the at least one coding key (K1, K2, K3).

47. The method according to claim 46, further comprising the following steps:
(S12) identifying a key information that denotes a coding key (K1, K2, K3) used for encryption in the encrypted data received via the transmission network (20); and
using that preset coding key (K1, K2, K3) that matches the key information detected for decrypting the data.

48. The method according to claim 46 or 47, further comprising the following steps:
(S8) encrypting the data to be transferred by a communication interface (31-37) via the transmission network (20) before the data is output to the transmission network (20) by the network component using the at least one preset coding key (K1, K2, K3); and
(S10) outputting the encrypted data to the transmission network (20).

49. The method according to claim 48, further comprising the following step:
(S9) adding a key identifier denoting the coding key (K1, K2, K3) used for encryption to the encrypted data before the encrypted data is output to the transmission network (20).

50. The method according to claim 48 or 49, further comprising the following steps:
(S2) calculating a check value for the data to be encrypted or for the encrypted data; and
(S3) adding the check value to the data to be encrypted before encryption or to the encrypted data after encryption.

51. The method according to any one of claims 46 through 50, further comprising the following steps:
(S15) identifying a check value in the encrypted data or in the decrypted data;
(S16) calculating a check sum for the data decrypted or encrypted using the at least one coding key (K1, K2, K3);
(S17) comparing the check sum with the check value; and
(S19) preventing the transfer of the decrypted data to the at least one assigned communication interface (31-37) if the check sum does not match the check value.

52. The method according to any one of claims 46 through 50, further comprising the following steps:
receiving unencrypted data transmitted by a communication interface (31-37) via the transmission network (20) by the respective network component (11-16);
detecting that the data received is not encrypted using a preset coding key (K1, K2, K3); and
preventing transfer of the unencrypted data to the at least one assigned communication interface (31-37) by the network component (11-16).

53. The method according to any one of claims 46 through 52, further comprising the following steps:
identifying a transmission protocol used in the transmission network (20) based on encrypted data received via the transmission network (20) using specifications of known transmission protocols;
detecting an unencrypted protocol data part that can only be put down to the respective transmission protocol used, and an encrypted use data part containing the remaining data, in the encrypted data received; and
decrypting only the encrypted user data using the at least one coding key (K1, K2, K3).

54. The method according to claim 53, further comprising the following steps:
creating a new protocol data part for the decrypted user data part using the specification of the identified transmission protocol and the detected protocol data part; and
Forming decrypted data according to the identified transmission protocol from the new protocol data part and the decrypted user data part.

55. The method according to claim 54, further comprising the following steps:
identifying a communication address used in the transmission network (20) for addressing a respective addressed communication interface (31-37) in the detected protocol data part; and
forming the new protocol data part for the decrypted user data part while retaining the detected communication address.

56. The method according to any one of claims 46 through 52,
further comprising the following steps:
receiving an unencrypted protocol data part via a first channel of the transmission network, said protocol data part specifying a communication address used in the respective transmission network (20) for addressing a respective communication interface (31-37);
receiving an encrypted user data part via a second channel of the transmission network that is different from the first channel of the transmission network, said user data part containing data to be transferred between communication interfaces (31-37);
wherein only the user data part received via the second channel is decrypted using a preset coding key (K1, K2, K3).

57. The method according to any one of claims 53 through 56,
further comprising the following steps:
identifying a communication address used in the transmission network (20) for addressing a respective transmitting communication interface (31-37) in the protocol data part detected or received via the first channel; and
assigning the identified communication address to a key identifier denoting the coding key (K1, K2, K3) used for decryption after decrypting the use data part received.

58. The method according to claim 57,
further comprising the following steps:
identifying a communication address used for addressing a respective transmitting communication interface (31-37) in the protocol data part of the data to be decrypted, which protocol data part is detected or received via the first channel;
identifying a key information that denotes the coding key (K1, K2, K3) used for encryption in the encrypted data received via the transmission network (20), or search for a key identifier assigned to this communication address; and
using the coding key (K1, K2, K3) assigned to the respective key identifier for decrypting the data.

59. The method according to any one of claims 53 through 55,
further comprising the following steps:
(S4) identifying a transmission protocol used in the transmission network (20) based on the unencrypted data received from the respective at least one assigned communication interface (31-37) using specifications of known transmission protocols;
(S5) detecting a protocol data part that can only be put down to the respective transmission protocol used, and a user data part containing the remaining data, in the data received; and
decrypting only the user data part using the at least one coding key (K1, K2, K3).

60. The method according to claim 59,
further comprising the following steps:
creating a new protocol data part for the encrypted use data part using the specification of the identified transmission protocol and the detected protocol data part; and
forming encrypted data according to the identified transmission protocol from the new protocol data part and the decrypted user data part.

61. The method according to claim 60,
further comprising the following steps:
identifying a communication address used in the transmission network (20) for addressing a respective addressed communication interface (31-37) in the detected protocol data part, and
forming of the new protocol data part for the encrypted user data part while retaining the detected communication address.

62. The method according to claim 57 or 58,
further comprising the following steps:
(S6) identifying of a communication address used for addressing a respective addressed communication interface (31-37) in the protocol data part detected or received via the first channel;
(S7) searching a key identifier assigned to this communication address; and
using the coding key (K1, K2, K3) assigned to the respective key identifier for encryption.

63. The method according to claim 62,
further comprising the following steps:
encrypting preset test data using any one preset coding key (K1, K2, K3); and
sending the encrypted test data to a respective addressed communication interface (31-37);
if no key identifier is assigned to the communication address used for addressing the respective addressed communication interface (31-37).

64. The method according to claim 62,
further comprising the following steps:
creating unencrypted user data specifying key identifiers that denote all or a subset of the preset coding keys (K1, K2, K3); and
sending the unencrypted user data to a respective addressed communication interface (31-37);
if no key identifier is assigned to the communication address used for addressing the respective addressed communication interface (31-37).

65. The method according to claim 64,
further comprising the following steps:
detecting that unencrypted user data specifying multiple key identifiers were received via the transmission network (20);
comparing of several key identifiers specified in the unencrypted use data received with the key identifiers that denote the preset coding keys (K1, K2, K3);
identifying a communication address used for addressing a respective transmitting communication interface (31-37) in the protocol data part detected or received via the first channel for the unencrypted user data received;
creating unencrypted user data specifying all common key identifiers; and
sending the unencrypted user data to a respective transmitting communication interface (31-37).

66. The method according to claim 65,
further comprising the following steps:
detecting that unencrypted use data specifying common key identifiers were received via the transmission network (20);
identifying a communication address used for addressing a respective transmitting communication interface (31-37) in the protocol data part detected or received via the first channel for the unencrypted user data received; and
assigning the identified communication address to the common key identifiers.

67. The method according to any one of claims 46 through 65,
further comprising the following steps:
detecting a user's identity;
comparing the detected identity with the identities of approved users; and
performing a decryption or encryption using a preset coding key (K1, K2, K3) only if the detected identity is assigned to an approved user.

68. The method according to any one of claims 46 through 67,
wherein the steps described are performed by a network component according to any one of claims 1 through 38.
